(19) United States
(12) Patent Application Publication
(10) Pub. No.: US 2026/0046364 A1
(43) Pub. Date: Feb. 12, 2026

(54) SYSTEM FOR SATELLITE DATA SESSION NOTIFICATION

(71) Applicant: T-MOBILE INNOVATIONS LLC, Overland Park, KS (US)

(72) Inventors: Kun Lu, Bellevue, WA (US); Hang Hoi Yau, Sammamish, WA (US); Jun Liu, Sammamish, WA (US)

(21) Appl. No.: 18/799,112

(22) Filed: Aug. 9, 2024

(51) Int. Cl. H04M 15/00; H04B 7/185; H04M 1/72403; H04W 76/30; H04W 84/06

(52) U.S. Cl. CPC H04M 15/853; H04B 7/18589; H04M 1/72403; H04W 76/30; H04W 84/06

(57) ABSTRACT

Systems, methods, and software are disclosed herein for monitoring network data service from a non-terrestrial cell in various implementations. In one example, a computing apparatus receives a service information block from a non-terrestrial cell hosting a current session of network data service to the computing apparatus. The computing apparatus processes a service time parameter of the service information block to determine a time remaining of the current session of the network data service. The computing apparatus then enables display, in a user interface of the computing apparatus, of a countdown timer based on the time remaining of the current session.

### TECHNICAL FIELD

Aspects of the disclosure are related to the field of wireless communication networks, particularly user equipment access to non-terrestrial network cells of wireless communication networks.

### BACKGROUND

Due to their extensive service coverage capabilities, non-terrestrial networks (NTNs) are anticipated to facilitate the deployment of wireless services in areas that cannot be served by terrestrial wireless networks such as 4G LTE or 5G NR. The deployment of multiple constellations of small satellites in low Earth orbit is expected to address the digital divide and provide internet and voice services to remote and underserved regions. This initiative is likely to enhance global communication infrastructure, enabling connectivity in areas with challenging topography and limited technological resources. Furthermore, NTNs are projected to support emergency response operations by providing reliable communication channels in disaster-stricken or isolated locations.

However, a substantial number of satellites are required to achieve coverage in remote or underserved locations. In the early stages of NTN deployment, the number of satellites in orbit may be insufficient to provide consistent and reliable direct-to-cell communications, resulting in interrupted services for user equipment (UE) due to discontinuous satellite coverage and posing challenges for users in such locations. Additionally, the intermittent coverage might impact various applications that depend on continuous connectivity, such as real-time data transmission and critical communication services.

### OVERVIEW

Technology is disclosed herein for monitoring network data service from a non-terrestrial cell in various implementations. In one example, a computing apparatus comprises one or more computer readable storage media, one or more processors operatively coupled with the one or more computer readable storage media and program instructions stored on the one or more computer readable storage media that, when executed by the one or more processors, direct the computing apparatus to receive a service information block from a non-terrestrial cell hosting a current session of network data service to the computing apparatus; process a service time parameter of the service information block to determine a time remaining of the current session of the network data service; and enable display, in a user interface of the computing apparatus, of a countdown timer based on the time remaining of the current session.

In another example, a method of operating a computing device comprises receiving a service information block from a non-terrestrial cell hosting a current session of network data service to the computing device; processing a service time parameter of the service information block to determine a time remaining of the current session of the network data service; and enabling display, in a user interface of the computing device, of a countdown timer based on the time remaining of the current session.

In yet another example of the technology disclosed herein, one or more computer readable storage media having program instructions stored thereon that, when executed by one or more processors, direct a computing apparatus to receive a service information block from a non-terrestrial cell hosting a current session of network data service to the computing apparatus; process a service time parameter of the service information block to determine a time remaining of the current session of the network data service; and enable display, in a user interface of the computing apparatus, of a countdown timer based on the time remaining of the current session.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for monitoring network data service from a non-terrestrial cell in an implementation.

FIG. 2 illustrates processes for monitoring network data service from a non-terrestrial cell in an implementation.

FIG. 3 illustrates an operational architecture for monitoring network data service from a non-terrestrial cell in an implementation.

FIG. 4 illustrates a workflow for monitoring network data service from a non-terrestrial cell in an implementation.

FIG. 5 illustrates user experiences of a system for monitoring network data service from a non-terrestrial cell in an implementation.

FIG. 6 illustrates user experiences for a system for monitoring network data service from a non-terrestrial cell in an implementation.

FIG. 7 illustrates an architecture for a network data center of wireless communication network in an implementation.

FIG. 8 illustrates a computing system suitable for implementing the various operational environments, architectures, processes, scenarios, and sequences discussed below with respect to the other Figures.

### DETAILED DESCRIPTION

In areas lacking ground-based infrastructure for network communication, such as remote or hard-to-reach locations, users in those areas may access a non-terrestrial network (NTN) for network data services. When a user equipment (UE) (e.g., a smartphone) in a remote location receives data service via an NTN of a wireless communication network, the satellites of the network will move in and out of the coverage area of the UE causing disruptions in the service to the UE. Because the satellites hosting the serving cells do not necessarily transit the same orbit, the disruptions to service can be irregular and therefore (from the user's perspective) unpredictable. Various implementations are disclosed herein for technology by which to monitor and provide notification to a user of a UE of the status of network data service hosted by an NTN including when service will end and when service will resume. In an implementation, an application executing on the UE receives service time data from the current serving cell hosting data service to the UE and, based on the service time data, generates and displays a visualization which indicates when data service will become unavailable (due to the current serving cell moving out of range) and when service (hosted by a follow-on serving cell coming into range) will resume. By providing such information to the user, the user experience is improved by providing a measure of predictability to the user. By allowing the user to monitor the availability of data service, the user can adapt his/her access to the data service based on knowing when and how long the service will be available and when or how long the service will be unavailable.

In various implementations, a UE establishes a wireless communication link (e.g., a Radio Resource Control (RRC) connection) with an orbiting cell (e.g., gNodeB) hosting 4G LTE, 5G-NR, or 6G service of a wireless communication network. Upon connecting with the wireless network, the UE receives service information including a Master Information Block (MIB) and Service Information Block 1 (SIB-1) per the 3GPP (Third Generation Partnership Project) specification. In various implementations, the UE confirms specific types of data service which are available to the device, such as messaging or SMS (Short Message Service), IMS (Internet Protocol or IP Multimedia Subsystem) service for emergency communications, and so on. For example, SIB-1 includes parameters which indicate whether support for emergency calls is available for the UE. The UE can consult various SIB parameters to determine what services (if any) are available to the device. If the UE is unable to confirm that data service is available, the UE does not display a countdown timer.

Upon connecting to the orbiting cell, the UE requests and receives Service Information Block 19 (SIB-19) including parameters relating to service hosted by the orbiting cells. The current orbiting cell may transmit SIB-19 periodically (e.g., every 480 milliseconds) or on request from a UE. Among the data transmitted in SIB-19, the UE receives a stop time parameter (e.g., t-Service) indicating the time when the current session of data service (from the current serving cell) to the coverage area of the UE will cease and a start time parameter (e.g., t-ServiceStart) for the next session of data service (from the next serving cell) to the coverage area will resume. In an implementation, based on the data received in SIB-19, the UE configures a display for the user interface of the device which includes a live countdown timer indicating the time remaining until the service that is currently being provided ceases. The UE may also display a second live countdown timer indicating the time until service hosted by the next satellite in the constellation begins.

In various implementations, to display the countdown timers, the UE executes an application which receives and processes the service time data (e.g., the t-Service and t-ServiceStart parameters) from the current serving cell and produces live or dynamic displays of service times based on the parameters, i.e., the time until the current serving cell is out of range of the UE and the time until the next serving cell is available to serve the UE. To process the service time data, the service time values and the current time are converted to a common format so that the difference between the service time values and current time can be determined. In many cases, the service time data is transmitted by the serving cell as a numerical value or timestamp which indicates a specific date/time in terms of the number of intervals from a specified epoch date/time. For example, the service time data may be specified in terms of multiples of 10 milliseconds since the epoch date of 00:00:00 UTC (Coordinated Universal Time) of 1 Jan. 1900 of the Gregorian calendar.

In an implementation, to process the service time parameters received from the serving cell, the application determines the local time zone of the UE based on the detected location of the UE and converts the service time values to times of the local time zone. For example, for a UE determined to be in the Mountain Standard Time (MST), the application converts the value of the t-Service parameter to MST and displays the difference between the current time and the converted t-Service value, where the difference is formatted in terms of hours, minutes, and seconds (e.g. hh: mm: ss). The application continually updates the display as the current time approaches the stop time for the current session (i.e., the converted t-Service value). In the same manner, the application may also generate a dynamic display of the start time of the next session of data service. The value of the t-ServiceStart parameter is converted to the local time zone of the UE and the difference between the start time of the next session and the current time is computed and configured for display, e.g., as a countdown timer. In various implementations, the UE periodically receives (or requests and receives) SIB-19 data from the current serving cell and recomputes the display times based on the latest service time data (i.e., the latest t-Service and t-ServiceStart values).

In some implementations, the application configures a display of the service time data including the stop and start times of the current and next sessions as clock times according to the local time zone. The user can select to view the desired format of the information in the user interface, for example, by selecting a graphical toggle which causes the display to switch between a countdown timer and clock time. In some scenarios, the application configures dynamic chart or visualization (e.g., pictorial graphic) depicting the time until service stops or starts.

In some implementations, the display of the current session countdown and next session countdowns may include visual enhancements which are activated when the countdown passes a threshold. For example, when there is less than two minutes remaining until the current session of network data service ends, the display may change colors (e.g., from black text to red text) to alert the user to the remaining time.

Technical effects of the technology disclosed herein include enabling a UE to receive and monitor service times for network data service hosted by an NTN and to generate a display in a user interface of the UE based on service times received from a serving cell of the NTN. The technical effects include receiving service time data and converting the data to a user-friendly, highly consumable format to improve the user experience. For example, the service time data may be converted to a local time zone of the device and an intuitive display of the information is presented and continually updated in the user interface. In this way, the user is notified about the status or availability of network service hosted by orbiting cells, which is particularly important for users in remote locations lacking terrestrial network coverage, such as remote, hard-to-reach locations. By providing a live display of service time information, the user can optimize his/her usage of data service to make the best use of the periods of time when network service is available. Moreover, the user's awareness of network availability can enable the user to use his/her device with greater discretion to conserve battery power, rather than wasting battery power trying to connect to the wireless network when no service is available, for example.

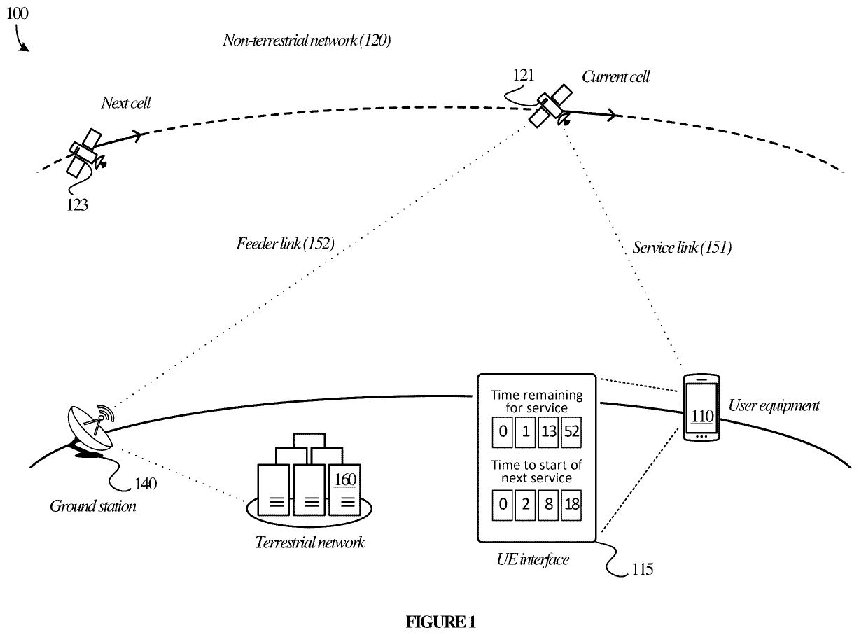

Turning now to the Figures, FIG. 1 illustrates operational environment 100 for monitoring service times for network data service hosted by cells of an NTN in an implementation. Operational environment 100 includes UE 110, terrestrial network 160, and NTN 120. UE 110 includes a user interface displaying user experience 115. NTN 120 includes current cell 121 and next cell 123 in orbit. Current cell 121 is in communication with UE 110 and ground station 140 via service link 151 and feeder link 152, respectively. Ground station 140 communicates with terrestrial network 160.

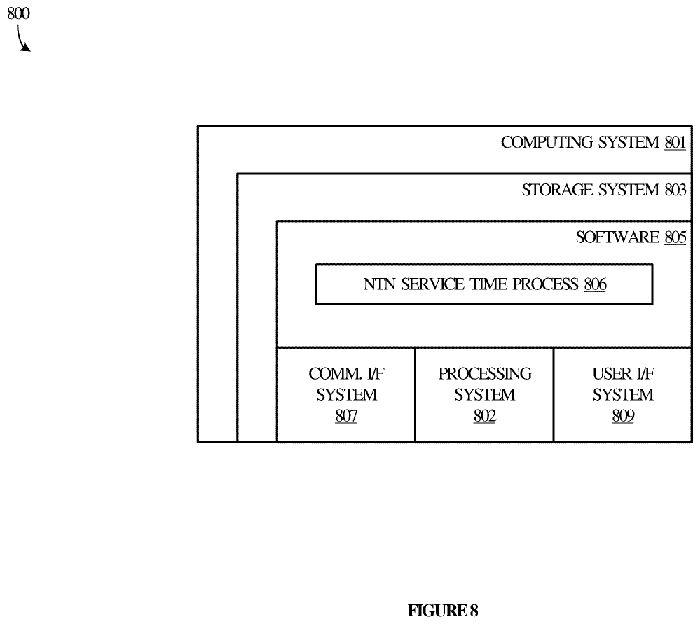

UE 110 is representative of a device, such as a smartphone, computer, sensor, controller, radio, and/or some other user apparatus, with processing circuitry for wireless communication with a cell (e.g., gNodeB) of a wireless network hosted by NTN 120. UE 110 exchanges wireless communication signals with orbiting cells of NTN 120 over radio frequency bands based on protocols such as Fifth Generation New Radio (5GNR), 5G Advanced, LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UE 110 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 801 in FIG. 8 is broadly representative.

NTN 120 is representative of a constellation of orbiting cells which broadcast radio signals comprising wireless communication for terrestrial network 160. NTN 120 can include Earth-orbiting satellites or high-altitude platform systems carrying serving cells. Current cell 121 and next cell 123 of NTN 120 are representative of cells onboard satellites or other aerial platforms which support wireless communication network, including IMS and data service, to devices such as UE 110. Current cell 121 or next cell 123 may include a gNodeB or eNodeB base station of a wireless communication network. An exemplary end-to-end communication path of elements of operational environment 100 relays communications from UE 110 to current cell 121 via service link 151, then to base station 140 via feeder link 152. From base station 140, communication is carried to a network core of terrestrial network 160 and on to an endpoint such as another UE, a data network, a cloud-based destination, etc.

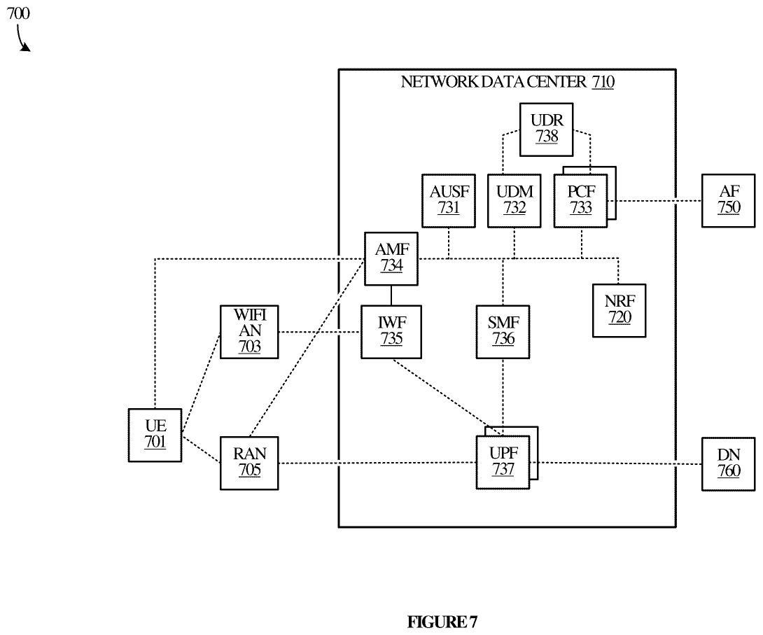

Terrestrial network 160 is representative of a communication network capable of using a Fifth Generation New Radio (5G-NR), 5G Advanced, 6G, LTE, or other protocol to provide network connectivity for wireless IMS and data service to wireless communication devices such as UE 110. In an implementation, terrestrial network 160 is representative of a service-based architecture (SBA) which includes network functions constituting the control plane and user plane elements of a network core, of which network data center 710 of FIG. 7 is representative. The network functions of terrestrial network 160 are implemented on one or more suitable computing devices, of which computing device 801 of FIG. 8 is representative. Examples of suitable computing devices include server computers, blade servers, and the like. The network elements of terrestrial network 160 may be implemented in the context of one or more data centers in a co-located or distributed manner, or in some other arrangement.

In a brief operational scenario of operational environment 100, UE 110 searches and discovers current cell 121 for network data service. UE 110 attaches to current cell 121 and confirms the availability of network data service hosted by current cell 121. UE 110 receives an SIB-19 communication from current cell 121 via service link 151 including service time parameters for the current session of data service (hosted by current cell 121) and the next session of data service to be hosted by next cell 123. Based on the service time parameters, UE 110 executes an application (not shown) which generates user experience 115 including a display based on the service time parameters. User experience 115 may be displayed in a user interface hosted by the application or on the home page or lock screen of UE 110. The display includes live countdown timers indicating the time remaining in the current session and time until the next session (to be hosted by next cell 123) begins. The application updates the display by continually recomputing the times displayed in the countdown timer based on the current time (e.g., by accessing a clock or time functionality of UE 110). UE 110 may also continue to receive SIB-19 transmissions including updated service time parameters on which the application recomputes the displayed countdown times.

Continuing with the brief operational scenario, when the current session of data service expires, UE 110 loses its connection to current cell 121. The application updates user experience 115 to show the countdown timer for the resumption of service. When next cell 123 comes into range of UE 110, UE 110 attaches to next cell 123 and confirms the availability of network data service. UE 110 receives an SIB-19 transmission from next cell 123 including new service time parameters for the next (now current) session of network data service. The application executing onboard UE 110 generates an updated display for user experience 115, including a countdown timer for the now current session of network data service hosted by next cell 123.

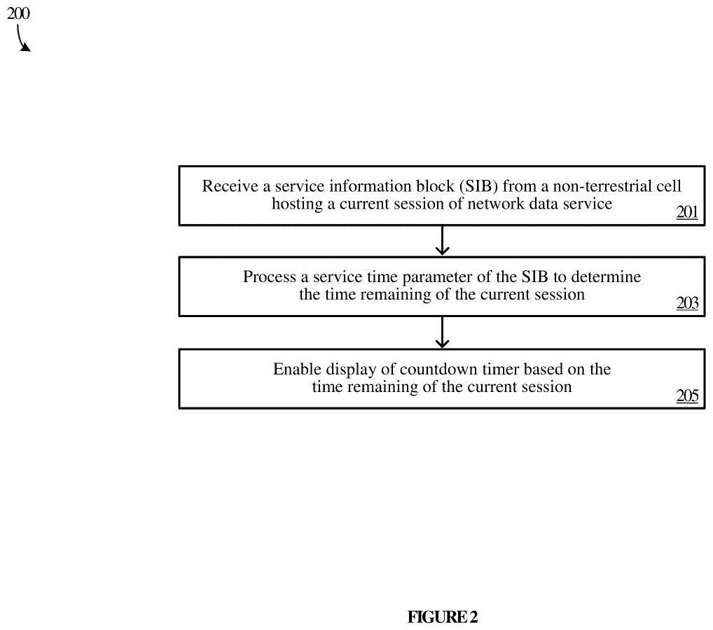

FIG. 2 illustrates a method for monitoring service times for network data service hosted by cells of an NTN in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, a computing device receives a service information block (SIB) from a non-terrestrial cell hosting a current session of network data service (step 201). In an implementation, the computing device, such as a smartphone or other mobile computing device, establishes a communication link with a terrestrial network, e.g., a wireless network, via an NTN. The computing device receives network data service via a communication link with a non-terrestrial serving cell, such as a gNodeB, onboard an orbiting satellite of the NTN. The computing device receives a service information block, such as an SIB-19 of the 3GPP standard, which includes operational parameters relating to communication between the computing device and the non-terrestrial cell onboard the satellite.

The computing device processes a service time parameter of the SIB to determine a time remaining of the current session of network data service hosted by the non-terrestrial cell (step 203). In an implementation, the service time parameter includes a time at which data service hosted by the non-terrestrial cell will cease to be available to the computing device. To determine the interval of time remaining in the current session, the value of the service time parameter and/or the current time is/are converted to a common format so that the difference between the parameter value and current time can be determined. For example, the computing device converts the service time parameter to a stop time in terms of the time zone of the computing device. The computing device may determine the time zone of the computing device based on the detected location of the computing device. The computing device computes the difference between the localized stop time and the current local time to determine the time remaining of the current session. For example, the service time parameter may be a t-Service parameter the value of which indicates the time of cessation of service in terms of a quantity of 10-ms increments of time since 00:00:00 UTC on 1 Jan. 1900 of the Gregorian calendar, such that cessation of service occurs in the interval of time between the value of the parameter less 1 and the value. The computing device converts the t-Service parameter value to a local time based on the detected location of the computing device. Thus, the difference between the converted t-Service parameter value and the current local time indicates the time remaining.

In some scenarios, the computing device determines the time remaining of the current session based on converting the local time to the format of the service time parameter, computing the difference, and converting the difference to days, hours, minutes, and seconds.

The computing device enables display of a countdown timer for the time remaining of the current session of the network data service (step 205). In an implementation, the computing device generates a dynamic display of the time remaining of the current session in user-friendly format which indicates the time remaining of the current session. For example, the dynamic display may include a digital display of values indicating the number of days, hours, minutes, and seconds for the time remaining. The numerical values may be continually updated based on counting down from the initial difference calculation, or the numerical values may be continually updated based on recomputing the time remaining based on updated service time parameters of SIB transmissions received from the non-terrestrial cell.

In some cases, the countdown timer may be a dynamic chart or graphic which visualizes the countdown using pictorial elements the size of which reflects the time remaining. For example, to reflect the live countdown of time, the graphical element (e.g., a line, arc, or sector) which reflects the time remaining may shrink or shorten to reflect the reduction in the time remaining. In some scenarios, the countdown timer may be a graphical representation of an analog clock or stopwatch indicating the time remaining. In some scenarios, the countdown timer may be accompanied by an audible notification of the time remaining, such as a tone indicating the time remaining.

In various implementations, the computing device also displays a countdown timer for the time for resumption of service, that is, the time when network data service resumes based on service from a next non-terrestrial serving cell. The computing device receives a start time parameter for the next serving cell of the NTN from the SIB (e.g., a t-ServiceStart parameter of a SIB-19 transmission) and converts the start time parameter to a local time based on the detected location or time zone of the computing device. The computing device determines the difference between the local start time and the current local time and generates a dynamic display of the difference. As with the displaying the countdown timer for the time remaining, the countdown timer for the start time of the next session of network data service may be displayed as a dynamic graphical representation (e.g., iconic or pictorial representation).

Referring again to FIG. 1, operational environment 100 illustrates a brief example of process 200 as employed by elements of operational environment 100. In operation, UE 110 is receiving network data service from terrestrial network 160 via current cell 121 onboard a satellite of NTN 120. UE 110 receives a service information block from current cell 121 including a service time parameter. UE 110 process the service time parameter to determine the time remaining for the current session of data service. To determine the time remaining, UE 110 converts the service time parameter to a local time, then computes the difference between the local time and the converted service time. UE 110 generates and displays user experience 115 including a countdown timer based on the time remaining.

In some implementations, UE 110 also receives a second service time parameter indicating a time to resumption of service to be hosted by next cell 123. UE 110 generates a second countdown timer for the time to resumption of service and displays the second timer in user experience 115.

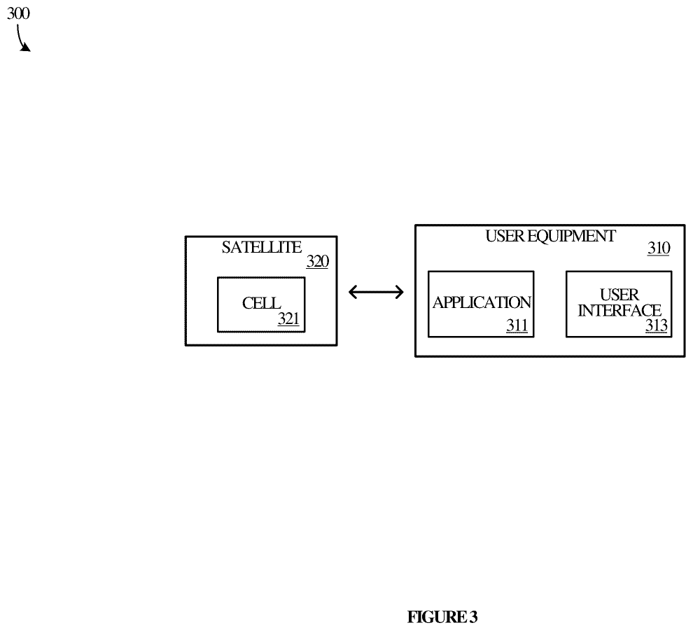

FIG. 3 illustrates operational architecture 300 for monitoring and providing notification of service times for network data service hosted by cells of an NTN in an implementation. Operational architecture 300 includes UE 310 in wireless communication with orbiting satellite 320. UE 310 includes application 311 and user interface 313. Satellite 320 includes cell 321.

UE 310 is representative of a computing device, such as a smartphone, computer, sensor, controller, radio, and/or some other user apparatus, with processing circuitry for wireless communication with a cell (e.g., gNodeB) of a wireless network. For example, UE 310 exchanges wireless communication signals with orbiting cells of a non-terrestrial network over radio frequency bands based on protocols such as Fifth Generation New Radio (5GNR), 5G Advanced, LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UE 310 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 801 in FIG. 8 is broadly representative.

Satellite 320 is representative of an orbiting platform including functionality for wireless communication with ground-based endpoints. Cell 321 onboard satellite 320 is representative of a network functionality which transmits and receives wireless communication signals, including IMS and data service transmissions, to devices such as UE 310. Cell 321 may include a gNodeB or eNodeB base station of a wireless communication network. In various implementations, cell 321 transmits operational parameters in the form of Master Information Blocks and Service Information Blocks per the 3GPP standard to devices such as UE 310.

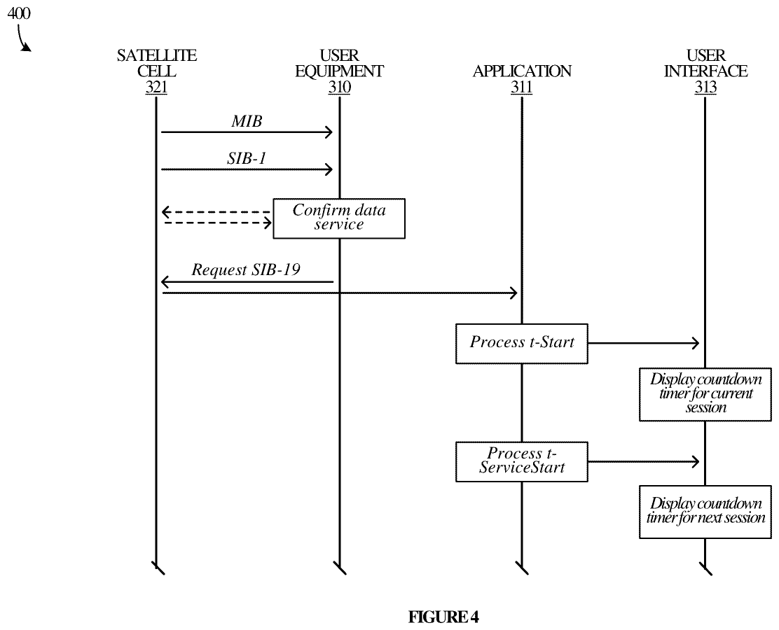

FIG. 4 illustrates workflow 400 for monitoring and providing notification of service times for network data service hosted by cells of an NTN in an implementation, referring to elements of operational architecture 300 of FIG. 3. In workflow 400, UE 310 attaches to a wireless communication network for network data service, establishing a communication link to the network via cell 321 of satellite 320. UE 310 receives MIB and SIB-1 from cell 321 including operational parameters for wireless communication. UE 310 confirms that network data service is available based on information received in various information blocks from cell 321. To confirm that network data service is active, UE 310 consults various operational parameters of MIB or SIB-1 or of another (requested and received) SIB, such as SIB-2. Upon confirming that network data service is available for UE 310, UE 310 pings cell 321 to receive SIB-19.

Upon receiving SIB-19, application 311 executing on UE 310 extracts service time parameters t-Service and t-ServiceStart. Application 311 processes each of the service time parameters to determine the time remaining for the current session of network data service provided by cell 321 and the time at which network data service will resume based on service from a follow-on cell. To process the service time parameters, the values of the parameters and the current time are converted to a common format so that the difference between the parameter values and current time can be determined. For example, the parameter values may be converted to a local time per the time zone of UE 310, or the current time may be converted to the format of the parameter values, or the parameter values and the current time may be converted to, for example, UTC times. In any case, with the parameter values and the current time in a common format, application 311 computes the differences to determine the time remaining for the current session of network data service (based on the t-Service parameter) and the time to start of the next session of network data service (based on the t-ServiceStart parameter).

Having determined the time remaining for the current session and the time to start of the next session, application 311 generates a dynamic display including countdown timers which are continually updated to show the computed times as the tick down to the respective session stop and session start times. In various implementations, application 311 may compute and update values for the dynamic display based on extrapolating from the initial difference calculation, or application 311 may recompute the difference calculation based on receiving updated parameters from SIB-19 transmissions from cell 321.

Subsequent to the current session of service ending, application 311 may refresh the display in user interface 313 to continue to show the countdown timer for the start of the next session of data service. When the next session of data service commences, application 311 once again confirms the availability of data service, then generates an updated display including a countdown timer for the time remaining for the new current session of data service and a second countdown timer for the time to the start of the new next session of service.

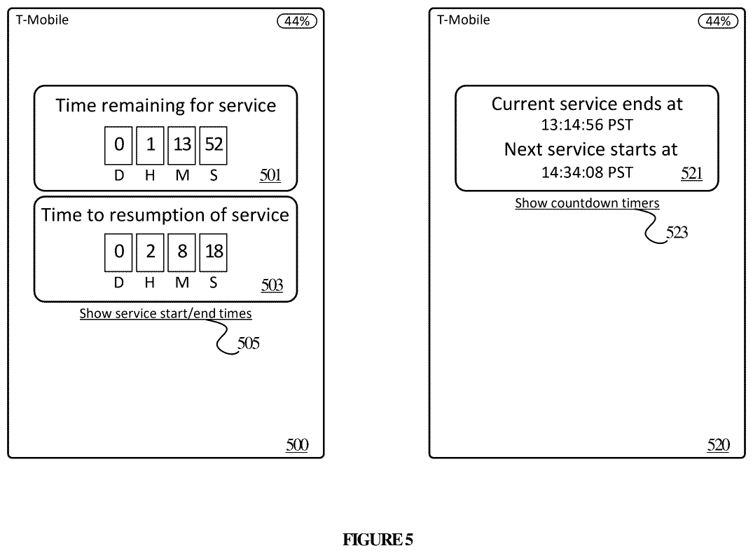

FIG. 5 depicts user experiences 500 and 520 displayed on a UE such as a smartphone or other computing device for monitoring and providing notification of service times for network data service hosted by non-terrestrial cells in an implementation. In various implementations, a UE is receiving network data service from a non-terrestrial serving cell such as a gNodeB onboard a satellite in low Earth orbit. The UE executes an application which generates the displays depicted in user experiences 500 and 520.

User experience 500 includes countdown timer 501 including a digital display of the time remaining for the current session of network data service. Countdown timer 501 is a dynamic display which is continually updated as the interval of time decreases. User experience 500 also includes countdown timer 503 including a digital display of the time to the start of the next session of network data service. As with countdown timer 501, countdown timer 503 is a dynamic display which is continually updated as the interval of time decreases. User experience 500 also includes graphical input device 505 (e.g., as a hyperlink or button) by which the user can toggle the display to replace countdown timers 501 and 503 with clock times for the stop time of the current session and the start time of the next session, as depicted in user experience 520.

User experience 520 includes information pane 521 including the stop time of the current session and the start time of the next session. As illustrated the stop and start times have been converted to the time zone of the UE hosting user experience 520 (e.g., Pacific Standard Time). The stop and start times are displayed in a hh: mm: ss format. User experience 520 includes graphical device 523 which when selected by the user toggles the display to the countdown timer format as depicted in user experience 500.

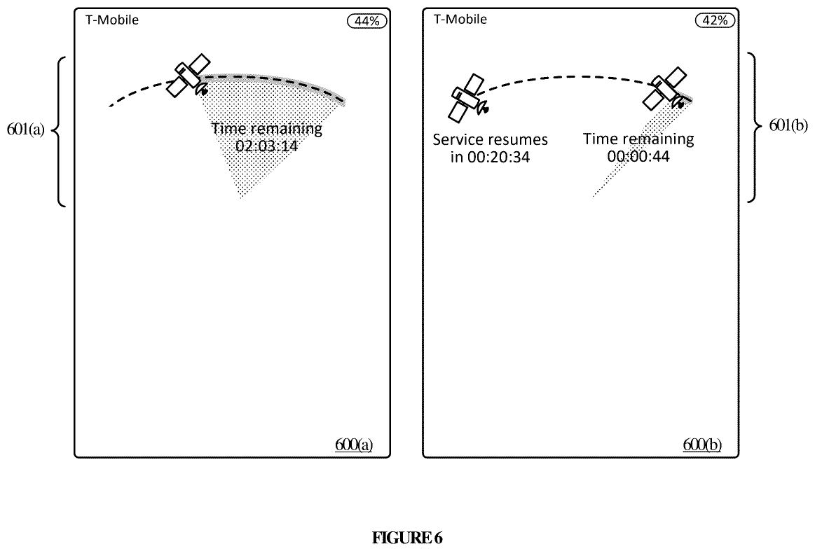

FIG. 6 depicts user experiences 600(a) and 615(b) displayed on a UE such as a smartphone or other computing device for monitoring and providing notification of service times for network data service hosted by non-terrestrial cells in an implementation. User experience 600(a) and 600(b) depict different stages of operation of a user interface hosted by an application for monitoring and providing notification of service times for non-terrestrial network data service.

User experiences 600(a) and 600(b) include graphical representations 601(a) and 601(b) of a countdown timer for the time remaining of a current session of network data service. Graphical representations 601(a) and 601(b) are live or dynamic images which are continually updated to reflect the current state of data service such that the central angle of the shaded sector decreases as time progresses. Similarly, the arcs depicting the paths of the satellite icons in graphical representations 601(a) and 601(b) decrease in length as time progresses. In some implementations, the graphical representations may also include text indicating the time remaining. In this way, the graphical format of the countdown timer provides the user with a more intuitive understanding of the availability of network data service. Various implementations of the countdown timer display may include some or all of the graphical elements of graphical representations 601(a) and 601(b) and may include elements of user experience 500 as well.

FIG. 7 illustrates exemplary wireless communication system 700 that serves wireless UEs such as UE 701. Wireless communication system 700 includes UE 701, Wifi Access Node (AN) 703, 5GNR radio access node (RAN) 705, Interworking Function (IWF) 735, Access and Mobility Management Function (AMF) 734, Authentication Server Function (AUSF) 731, Unified Data Management (UDM) 732, Policy Control Functions (PCFs) 733, Session Management Function (SMF) 736, User Plane Function (UPF) 737, Uniform Data Repository (UDR) 738, and Application Function (AF) 750. UDR 738 stores network data including subscriber profiles including identities, subscription details, service preferences, authentication credentials, and billing information. UDR 738 may also store policy data such as network rules, access rules, mobility rules, charging rules, and so on. AF 750 may provide policies applicable to control plane functions, that is, to the application, presentation, and/or session layers of the OSI protocol stack. IWF 735 includes non-3GPP IWFs (N3IWFs) for providing untrusted non-3GPP access to network data center 710, such as access via a non-cellular access network. DN 760 is representative of a data network, Internet access, third-party resource, or other endpoint of an end-to-end communication path from UE 701.

In an implementation, UE 701 communicates with network data center 710 via 5G-NR RAN 705 onboard a non-terrestrial platform, such as an orbiting satellite. UE 701 requests access to the wireless communication network hosted by wireless communication system 700 via a service link such as a Uu link to NR RAN 705. NR RAN 705 relays communications from UE 701 to ground-based network data center 710 via a feeder link.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements NTN service time process 806, which is (are) representative of the NTN service time processes discussed with respect to the preceding Figures, such as process 200 and workflow 400. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including NTN service time process 806) may be implemented in program instructions and among other functions may, when executed by processing system 802, direct processing system 802 to operate as described with respect to the various operational scenarios, sequences, and processes illustrated herein. For example, software 805 may include program instructions for implementing an NTN service time process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support NTN service time processes in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to. ” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S. C. § 112(f) will begin with the words “means for,” but use of the term “for” in any other context is not intended to invoke treatment under 35 U.S. C. § 112(f). Accordingly, the applicant reserves the right to pursue additional claims after filing this application to pursue such additional claim forms, in either this application or in a continuing application.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive a service information block from a non-terrestrial cell hosting a current session of network data service to the computing apparatus;
process a service time parameter of the service information block to determine a time remaining of the current session of the network data service; and
enable display, in a user interface of the computing apparatus, of a countdown timer based on the time remaining of the current session.

2. The computing apparatus of claim 1, wherein the program instructions further direct the computing apparatus to confirm an availability of network data service to the computing apparatus from the non-terrestrial cell and wherein to enable the display of the countdown timer in the user interface of the computing apparatus, the program instructions direct the computing apparatus to enable the display of the countdown timer based on confirming the availability of the network data service to the computing apparatus.

3. The computing apparatus of claim 2, wherein the program instructions further direct the computing apparatus to:
process a service start parameter of the service information block to determine a time to start of a next session of the network data service, wherein the next session of the network data service is hosted by a next non-terrestrial cell to the computing apparatus; and
enable display, in the user interface of the computing apparatus, of a second countdown timer based on the time to start of the next session of the network data service.

4. The computing apparatus of claim 3, wherein the countdown timer comprises the time remaining of the current session in a format comprising hours, minutes, and seconds.

5. The computing apparatus of claim 3, wherein to enable the display of the countdown timer, the program instructions direct the computing apparatus to generate a dynamic graphical representation of the time remaining of the current session of the network data service.

6. The computing apparatus of claim 3, wherein to process the service time parameter of the service information block, the program instructions direct the computing apparatus to convert a value of the service time parameter to a local time based on a detected location of the computing apparatus.

7. The computing apparatus of claim 3, wherein the program instructions further direct the computing apparatus to:
receive a next service information block from the next non-terrestrial cell hosting the next session of the network data service to the computing apparatus; and
update the countdown timer in the user interface according to a next service time parameter from the next service information block.

8. The computing apparatus of claim 1, wherein to receive the Service Information Block from the non-terrestrial cell, the program instructions direct the computing apparatus to receive the service information block from the non-terrestrial cell based on transmitting a request for the service information block to the non-terrestrial cell.

9. A method of operating a computing device comprising:
receiving a service information block from a non-terrestrial cell hosting a current session of network data service to the computing device;
processing a service time parameter of the service information block to determine a time remaining of the current session of the network data service; and
enabling display, in a user interface of the computing device, of a countdown timer based on the time remaining of the current session.

10. The method of claim 9, further comprising confirming an availability of network data service to the computing device from the non-terrestrial cell and wherein enabling the display of the countdown timer in the user interface of the computing device comprises enabling the display of the countdown timer based on confirming the availability of the network data service to the computing device.

11. The method of claim 10, further comprising:
processing a service start parameter of the service information block to determine a time to start of a next session of the network data service, wherein the next session of the network data service is hosted by a next non-terrestrial cell to the computing device; and
enabling display, in the user interface of the computing device, of a second countdown timer based on the time to start of the next session of the network data service.

12. The method of claim 11, wherein the display of the countdown timer comprises a dynamic graphical representation of the time remaining of the current session of the network data service.

13. The method of claim 11, wherein processing the service time parameter of the service information block comprises converting a value of the service time parameter to a local time based on a detected location of the computing device.

14. The method of claim 11, further comprising:
receiving a next service information block from the next non-terrestrial cell hosting the next session of the network data service to the computing device; and
updating the countdown timer in the user interface according to a next service time parameter from the next service information block.

15. One or more computer readable storage media having program instructions stored thereon that, when executed by one or more processors, direct a computing apparatus to at least:
receive a service information block from a non-terrestrial cell hosting a current session of network data service to the computing apparatus;
process a service time parameter of the service information block to determine a time remaining of the current session of the network data service; and
enable display, in a user interface of the computing apparatus, of a countdown timer based on the time remaining of the current session.

16. The one or more computer readable storage media of claim 15, wherein the program instructions further direct the computing apparatus to confirm an availability of network data service to the computing apparatus from the non-terrestrial cell and wherein, to enable the display of the countdown timer in the user interface of the computing apparatus, the program instructions direct the computing apparatus to enable the display of the countdown timer based on confirming the availability of the network data service to the computing apparatus.

17. The one or more computer readable storage media of claim 16, wherein the program instructions further direct the computing apparatus to:
process a service start parameter of the service information block to determine a time to start of a next session of the network data service, wherein the next session of the network data service is hosted by a next non-terrestrial cell to the computing apparatus; and
enable display, in the user interface of the computing apparatus, of a second countdown timer based on the time to start of the next session of the network data service.

18. The one or more computer readable storage media of claim 17, wherein to enable the display of the countdown timer, the program instructions direct the computing apparatus to generate a dynamic graphical representation of the time remaining of the current session of the network data service.

19. The one or more computer readable storage media of claim 17, wherein to process the service time parameter of the service information block, the program instructions direct the computing apparatus to convert a value of the service time parameter to a local time based on a detected location of the computing apparatus.

20. The one or more computer readable storage media of claim 17, wherein the program instructions further direct the computing apparatus to:
receive a next service information block from the next non-terrestrial cell hosting the next session of the network data service to the computing apparatus; and
update the countdown timer in the user interface according to a next service time parameter from the next service information block.
